(19) United States
(12) Patent Application Publication
(10) Pub. No.: US 2014/0045070 A1
(43) Pub. Date: Feb. 13, 2014

(54) ELECTROCHEMICAL CELLS COMPRISING POLYIMIDES

(71) Applicants: Anna Mueller-Cristadoro, Heppenheim (DE); Helmut Moehwald, Annweiler (DE); Bernd Bruchmann, Freinsheim (DE); Raimund Pietruschka, Ebertsheim (DE); Ingrid Haupt, Frankenthal (DE)

(72) Inventors: Anna Mueller-Cristadoro, Heppenheim (DE); Helmut Moehwald, Annweiler (DE); Bernd Bruchmann, Freinsheim (DE); Raimund Pietruschka, Ebertsheim (DE); Ingrid Haupt, Frankenthal (DE)

(73) Assignee: BASF SE, Ludwigshafen (DE)

(21) Appl. No.: 14/112,554

(22) PCT Filed: May 15, 2012
(86) PCT No.: PCT/IB2012/052411

§ 371 Date: Oct. 18, 2013

(30) Foreign Application Priority Data
May 19, 2011 (EP) 11166678.0

(51) Int. Cl. H01M 2/16; H01M 2/14

(52) U.S. Cl. CPC H01M 2/1653; H01M 2/145
USPC 429/223; 528/350; 528/84; 524/590; 524/600; 429/249; 429/231.8; 264/334

(57) ABSTRACT

Electrochemical cell comprising (A) at least one anode as component (A), (B) at least one cathode as component (B), (C) at least one non-aqueous electrolyte as component (C), (D) at least one separator positioned between anode (A) and cathode (B), as component (D), characterized in that separator (D) is manufactured from at least one polyimide selected from branched condensation products of (a) at least one polycarboxylic acid having at least 3 COOH groups per molecule or an anhydride or ester thereof, and (b) and at least one compound, selected from (b1) at least one polyamine having on average more than two amino groups per molecule and (b2) at least one polyisocyanate having on average more than two isocyanate groups per molecule.

The present invention is directed towards an electrochemical cell comprising
(A) at least one anode as component (A),
(B) at least one cathode as component (B),
(C) at least one none-aqueous electrolyte as component (C),
(D) at least one separator positioned between anode (A) and cathode (B), as component (D), characterized in that separator (D) is manufactured from at least one polyimide selected from branched condensation products of
   (a) at least one polycarboxylic acid having at least 3 COOH groups per molecule or an anhydride or ester thereof, and
   (b) at least one compound, selected from
      (b1) at least one polyamine having on average more than two amino groups per molecule and
      (b2) at least one polyisocyanate having on average more than two isocyanate groups per molecule.

Furthermore, the present invention is directed towards separators for electrochemical cells. Furthermore, the present invention is directed towards a method for manufacturing inventive separators.

Batteries and electrochemical cells with non-aqueous electrolytes are currently of great interest. Many components are of significance, such as the electrodes and the electrolyte. However, particular attention will be paid to the separator which physically separates the anode and the cathode, thereby preventing short circuits.

On one hand, the separator should allow Lithium ions to pass. On the other hand, a separator should have the necessary mechanical properties to effectively separate anode and cathode from each other.

Longevity is still an issue for lithium ion batteries. Sometimes, it has been observed that batteries produce short circuits after a number of cycles such as 40 or 50 cycles.

It was therefore an objective to provide electrochemical cells that do not suffer from short circuits after longer operation, such as after repeated cycling. It was further an objective to provide components for electrochemical cells that do not suffer from short circuits after longer operation. Furthermore, it was an objective to provide a method for manufacturing batteries that do not suffer from short circuits after longer operation.

Accordingly, the above electrochemical cells were found, hereinafter also referenced as inventive cells.

### Inventive Cells Comprise

(A) at least one anode as component (A), briefly also referred to as anode (A),
(B) at least one cathode as component (B), briefly also referred to as cathode (B),
(C) at least one non-aqueous electrolyte as component (C), briefly also referred to as electrolyte (C),
(D) at least one separator positioned between anode (A) and cathode (B), as component (D) or separator (D), characterized in that separator (D) is manufactured from at least one polyimide selected from branched condensation products of
(a) at least one polycarboxylic acid having at least 3 COOH groups per molecule or a respective anhydride or ester thereof,
(b) at least one compound, selected from
   (b1) at least one polyamine having on average more than two amino groups per molecule and
   (b2) at least one polyisocyanate having on average more than two isocyanate groups per molecule.

Inventive cells can be selected from alkali metal containing cells. Preferably, inventive cells are selected from lithium-ion containing cells. In lithium-ion containing cells, the charge transport is effected by Li⁺ ions.

In the context with the present invention, the electrode where during discharging a net negative charge occurs is called the anode.

Anode (A) can be selected from anodes being based on various active materials. Suitable active materials are metallic lithium, carbon-containing materials such as graphite, graphene, charcoal, expanded graphite, furthermore lithium titanate (Li₄Ti₅O₁₂), tin oxide (SnO₂), and nanocrystalline silicium.

In a special embodiment of the present invention, anode (A) is selected from graphite anodes and lithium titanate anodes.

Anode (A) can further comprise a current collector. Suitable current collectors are, e.g., metal wires, metal grids, metal gaze and preferably metal foils such as copper foils.

Anode (A) can further comprise a binder. Suitable binders can be selected from organic (co)polymers. Suitable organic (co)polymers may be halogenated or halogen-free. Examples are polyethylene oxide (PEO), cellulose, carboxymethyl cellulose, polyvinyl alcohol, polyethylene, polypropylene, polytetrafluoroethylene, polyacrylonitrile-methyl methacrylate, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partially neutralized with alkali metal salt or ammonia, ethylene-methacrylic acid copolymers, optionally at least partially neutralized with alkali metal salt or ammonia, ethylene-(meth)acrylic ester copolymers, polysulphones, polyimides and polyisobutene.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

The average molecular weight M_{w} of binder may be selected within wide limits, suitable examples being 20,000 g/mol to 1,000,000 g/mol.

In one embodiment of the present invention, anode (A) can have a thickness in the range of from 15 to 200 μm, preferably from 30 to 100 μm, determined without the current collector.

Inventive cells further comprise a cathode (B). Cathode (B) can be, e.g., air (or oxygen). In a preferred embodiment, however, cathode (B) contains a solid active material.

Solid active materials for cathode (B) can be selected from phosphates with olivine structure such as lithium iron phosphates (LiFePO₄) and lithium manganese phosphate (LiMnPO₄) which can have a stoichiometric or non-stoichiometric composition and which can be doped or not doped.

In one embodiment of the present invention, active material for cathode (B) can be selected from lithium containing transition metal spinels and lithium transition metal oxides with a layered crystal structure. In such cases, cathode (B) contains at least one material selected from lithium containing transition metal spinels and lithium transition metal oxides with a layered crystal structure, respectively.

In one embodiment of the present invention, lithium-containing metal spinels are selected from those of the general formula (I)

LiₐM¹_{b}Mn_{3-a-b}O_{4-d} (I)

the integers being defined as follows:
0.9≦a≦1.3, preferably 0.95≦a≦1.15,
0≦b≦0.6, for example 0.0 or 0.5,
wherein, if M¹=Ni, 0.4≦b≦0.55,
−0.1≦d≦0.4, preferably 0≦d≦0.1,

M¹ is selected from one or more out of Al, Mg, Ca, Na, B, Mo, W and transition metals of the first row of the transition metals in the periodic table of the elements. In a preferred embodiment, M¹ is selected from the group consisting of Ni, Co, Cr, Zn, and Al. Even more preferably, M¹ is defined to be Ni.

In one embodiment of the present invention, lithium containing metal spinels are selected from LiNi_{0.5}Mn_{1.5}O_{4-d} and LiMn₂O₄.

In one embodiment of the present invention, lithium transition metal oxides with a layered crystal structure are selected from compounds of general formula (II)

Li₁₊ₜM²₁₋ₜO₂ (II)

the integer being defined as follows:
0≦t≦0.3 and

M² selected from one or more elements from Al, Mg, B, Mo, W, Na, Ca and transition metals of the first row of the transition metals in the periodic table of the elements, at least one element being manganese.

In one embodiment of the present invention, at least 30 mole-% of M² are selected from manganese, preferably at least 35 mole-%, in each time with respect to the complete amount of M².

In one embodiment of the present invention M² is selected from combinations of Ni, Co and Mn not containing significant amounts of additional elements.

In a different embodiment of the present invention M² is selected from combinations of Ni, Co and Mn containing significant amounts of at least one additional element, for example in the range of from 1 to 10 mole-% Al, Ca or Na.

In a particular embodiment of the present invention, lithium transition metal oxides with a layered crystal structure are selected from compounds of general formula

Li₍₁₊ₓ₎[NiₑCo_{f}Mn_{g}M³ₕ]₍₁₋ₓ₎O₂ (III)

the integers being defined as follows:
x a number in the range of from zero to 0.2,
e a number in the range of from 0.2 to 0.6,
f a number in the range of from 0.1 to 0.5,
g a number in the range of from 0.2 to 0.6,
h a number in the range of from zero to 0.1,
and: e+f+g+h=1,
M³ selected from Al, Mg, V, Fe, Cr, Zn, Cu, Ti and Mo.

In one embodiment of the present invention, M² in formula (II) is selected from Ni_{0.33}Co_{0.33}Mn_{0.33}, Ni_{0.5}Co_{0.2}Mn_{0.3}, Ni_{0.4}Co_{0.3}Mn_{0.4}, Ni_{0.4}Co_{0.2}Mn_{0.4} and Ni_{0.45}Co_{0.10}Mn_{0.45}.

Cathode (B) can further comprise a current collector. Suitable current collectors are, e.g., metal wires, metal grids, metal gaze and preferably metal foils such as aluminum foils.

Cathode (B) can further comprise a binder. Suitable binders can be selected from organic (co)polymers. Suitable organic (co)polymers may be halogenated or halogen-free. In general, the same binders used for anode (A) can also be employed for cathode (B).

Preferred binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In one embodiment of the present invention, cathode (B) can have a thickness in the range of from 15 to 200 μm, preferably from 30 to 100 μm, determined without the current collector.

Cathode (B) can further comprise electrically conductive carbonaceous material.

Electrically conductive carbonaceous material can be selected, for example, from graphite, carbon black, carbon nanotubes, graphene or mixtures of at least two of the aforementioned substances. In the context of the present invention, electrically conductive, carbonaceous material can also be referred to as carbon for short.

In one embodiment of the present invention, electrically conductive carbonaceous material is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, electrically conductive carbonaceous material is partially oxidized carbon black.

Inventive electrochemical cells further comprise at least one electrolyte (C). Electrolyte (C) in the context of the present invention can encompass at least one salt, preferably a lithium salt, and at least one non-aqueous solvent.

In one embodiment of the present invention, nonaqueous solvent may be liquid or solid at room temperature, preferably selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5,000,000 g/mol, preferably up to 2,000,000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (IV) and (V)

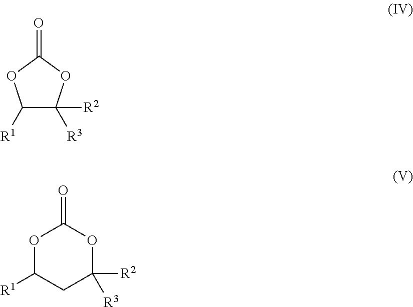

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (VI).

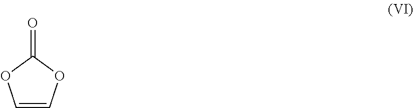

The solvent(s) is (are) preferably used in what is known as the anhydrous state, i.e. with a water content in the range from 1 ppm to 0.1% by weight, determinable, for example, by Karl Fischer titration.

Electrolyte further comprises one or more conductive salts. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, LiPF_{w}(CₙF₂ₙ₊₁)_{6-w}, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

The integer w is a number in the range of from 1 to 6, preferably w=3.

Preferred conductive salts are selected from LiC(CF₃SO₂)₃, LiN(CF₃SO₂)₂, LiPF₆, LiBF₄, LiClO₄, and LiPF₃(CF₂CF₃)₃, particular preference being given to LiPF₆, LiPF₃(CF₂CF₃)₃ and LiN(CF₃SO₂)₂.

In one embodiment of the present invention, the concentration of conductive salt in electrolyte is in the range of from 0.01 M to 5 M, preferably 0.5 M to 1.5 M.

Inventive electrochemical cells further comprise at least one separator (D), said separator being positioned between anode (A) and cathode (B).

In one embodiment of the present invention, separator (D) is positioned between anode (A) and cathode (B) in a way that it is like a layer to either a major part of one surface of anode (A) or cathode (B).

In one embodiment of the present invention, separator (D) is positioned between anode (A) and cathode (B) in a way that it is like a layer to both a major part of one surface of anode (A) and cathode (B).

In a preferred embodiment of the present invention, separator (D) is positioned between anode (A) and cathode (B) in a way that it is like a layer to one surface of anode (A) or of cathode (B).

In another preferred embodiment of the present invention, separator (D) is positioned between anode (A) and cathode (B) in a way that it is like a layer to one surface of both anode (A) and of cathode (B).

In one embodiment of the present invention, separator (D) has a thickness in the range of from 10 μm to 100 μm, preferably 15 μm to 35 μm.

In one embodiment of the present invention, the specific ionic conductivity at room temperature of separator (D) in liquid electrolyte is in the range of from 10⁻⁶ S/cm to 10⁻³S/cm, determined by impedance measurements of sandwich cells with separator/electrolyte combinations.

Separator (D) is manufactured from at least one polyimide, said polyimide being characterized below. To be manufactured in the context of the separator means that the separator is manufactured using at least one branched polyimide, preferably as the main component of separator and even more preferably as sole component.

In one embodiment of the present invention, separator further contains one or more inorganic particles (E). Inorganic particles can be selected, e.g., from oxides of Ti, Zr, Si or Al, non-stoichiometric or stoichiometric, preferred is SiO₂.

Polyimide from which separator (D) is manufactured is a branched polyimide and is selected from condensation products of
(a) at least one polycarboxylic acid having at least 3 COOH groups per molecule or anhydride or ester thereof, and
(b) at least one compound, selected from
   (b1) at least one polyamine having on average more than two amino groups per molecule, and preferably, also referred to as polyamine (b1), and preferably from
   (b2) at least one polyisocyanate having on average more than two isocyanate groups per molecule, also referred to as polyisocyanate (b2).

Said polyimide is briefly referred to as branched polyimide.

Branched polyimide can have a molecular weight M_{w} in the range from 1,000 to 200,000 g/mol; preference is given to 2,000 to 20,000 g/mol.

Branched polyimide can have at least two imide groups per molecule; preference is given to at least 3 imide groups per molecule.

In one embodiment of the present invention, branched polyimide can have up to 1,000 imide groups per molecule, preferably up to 660 per molecule.

In one embodiment of the present invention, stating the isocyanate groups or the COOH groups per molecule in each case denotes the mean value (number-average).

Branched polyimide can be composed of structurally and molecularly uniform molecules. However, preference is given to branched polyimides being mixtures of molecularly and structurally differing molecules, for example, visible from the polydispersity M_{w}/Mₙ of at least 1.4, preferably M_{w}/Mₙ of 1.4 to 50, preferably 1.5 to 10. The polydispersity can be determined by known methods, in particular by gel permeation chromatography (GPC). A suitable standard is, for example, poly(methyl methacrylate) (PMMA).

In one embodiment of the present invention, polyimide, in addition to imide groups which form the polymer backbone, comprises, terminally or in side chains, in addition at least three, preferably at least six, more preferably at least ten, terminal or side-chain functional groups. Functional groups in branched polyimide are preferably anhydride or acid groups and/or free or capped NCO groups. Branched polyimides preferably have no more than 500 terminal or side-chain functional groups, preferably no more than 100.

Alkyl groups such as, for example, methyl groups are therefore not a branching of a molecule of branched polyimide.

As polycarboxylic acids (a), aliphatic, or preferably aromatic, polycarboxylic acids are selected that have at least three COOH groups per molecule, or the respective anhydrides, preferably if they are present in low-molecular weight, that is to say non-polymeric, form. Such polycarboxylic acids having three COOH groups in which two carboxylic acids groups are present as anhydride and the third as a free carboxylic acid are also comprised.

In a preferred embodiment of the present invention, as polycarboxylic acid (a), a polycarboxylic acid having at least 4 COOH groups per molecule, or the respective anhydride, is selected.

Examples of polycarboxylic acids (a) and anhydrides thereof are 1,2,3-benzenetricarboxylic acid and 1,2,3-benzenetricarboxylic dianhydride, 1,3,5-benzenetricarboxylic acid (trimesic acid), preferably 1,2,4-benzenetricarboxylic acid (trimellitic acid), trimellitic anhydride and, in particular, 1,2,4,5-benzenetetracarboxylic acid (pyromellitic acid) and 1,2,4,5-benzenetetracarboxylic dianhydride (pyromellitic dianhydride), 3,3′,4,4″-benzophenonetetracarboxylic acid, 3,3′,4,4″-benzophenonetetracarboxylic dianhydride, in addition benzenehexacarboxylic acid (mellitic acid) and anhydrides of mellitic acid.

Other suitable polycarboxylic acids (a) and anhydrides thereof are mellophanic acid and mellophanic anhydride, 1,2,3,4-benzenetetracarboxylic acid and 1,2,3,4-benzenetetracarboxylic dianhydride, 3,3,4,4-biphenyltetracarboxylic acid and 3,3,4,4-biphenyltetracarboxylic dianhydride, 2,2,3,3-biphenyltetracarboxylic acid and 2,2,3,3-biphenyltetracarboxylic dianhydride, 1,4,5,8-naphthalenetetracarboxylic acid and 1,4,5,8-naphthalenetetracarboxylic dianhydride, 1,2,4,5-naphthalenetetracarboxylic acid and 1,2,4,5-naphthalenetetracarboxylic dianhydride, 2,3,6,7-naphthalenetetracarboxylic acid and 2,3,6,7-naphthalenetetracarboxylic dianhydride, 1,4,5,8-decahydronaphthalenetetracarboxylic acid and 1,4,5,8-decahydronaphthalenetetracarboxylic dianhydride, 4,8-dimethyl-1,2,3,5,6,7-hexahydronaphthalene-1,2,5,6-tetracarboxylic acid and 4,8-dimethyl-1,2,3,5,6,7-hexahydronaphthalene-1,2,5,6-tetracarboxylic dianhydride, 2,6-dichloronaphthalene-1,4,5,8-tetracarboxylic acid and 2,6-dichloronaphthalene-1,4,5,8-tetracarboxylic dianhydride, 2,7-dichloronaphthalene-1,4,5,8-tetracarboxylic acid and 2,7-dichloronaphthalene-1,4,5,8-tetracarboxylic dianhydride, 2,3,6,7-tetrachloronaphthalene-1,4,5,8-tetracarboxylic acid and 2,3,6,7-tetrachloronaphthalene-1,4,5,8-tetracarboxylic dianhydride, 1,3,9,10-phenanthrenetetracarboxylic acid and 1,3,9,10-phenanthrenetetracarboxylic dianhydride, 3,4,9,10-perylenetetracarboxylic acid and 3,4,9,10-perylenetetracarboxylic dianhydride, bis(2,3-dicarboxyphenyl)methane and bis(2,3-dicarboxyphenyl)methane dianhydride, bis(3,4-dicarboxyphenyl)methane and bis(3,4-dicarboxyphenyl)methane dianhydride, 1,1-bis(2,3-dicarboxyphenyl)ethane and 1,1-bis(2,3-dicarboxyphenyl)ethane dianhydride, 1,1-bis(3,4-dicarboxyphenyl)ethane and 1,1-bis(3,4-dicarboxyphenyl)ethane dianhydride, 2,2-bis(2,3-dicarboxyphenyl)propane and 2,2-bis(2,3-dicarboxyphenyl)propane dianhydride, 2,3-bis(3,4-dicarboxyphenyl)propane and 2,3-bis(3,4-dicarboxyphenyl)propane dianhydride, bis(3,4-carboxyphenyl)sulfone and bis(3,4-carboxyphenyl)sulfone dianhydride, bis(3,4-carboxyphenyl)ether and bis(3,4-carboxyphenyl)ether dianhydride, ethylenetetracarboxylic acid and ethylenetetracarboxylic dianhydride, 1,2,3,4-butanetetracarboxylic acid and 1,2,3,4-butanetetracarboxylic dianhydride, 1,2,3,4-cyclopentanetetracarboxylic acid and 1,2,3,4,-cyclopentanetetracarboxylic dianhydride, 2,3,4,5-pyrrolidinetetracarboxylic acid and 2,3,4,5-pyrrolidinetetracarboxylic dianhydride, 2,3,5,6-pyrazinetetracarboxylic acid and 2,3,5,6-pyrazinetetracarboxylic dianhydride, 2,3,4,5-thiophenetetracarboxylic acid and 2,3,4,5-thiophenetetracarboxylic dianhydride.

In one embodiment of the present invention, anhydrides from U.S. Pat. No. 2,155,687 or U.S. Pat. No. 3,277,117 are used for synthesizing a branched polyimide.

Polycarboxylic acid (a) or its respective anhydride can be reacted with at least one compound (b), selected from
(b1) at least one polyamine having on average more than two amino groups per molecule, also referred to as polyamine (b1), and preferably,
(b2) at least one polyisocyanate having on average more than two isocyanate groups per molecule, also referred to as polyisocyanate (b2).

Preferably, polycarboxylic acid (a) or its respective anhydride will be reacted

either with at least one polyamine (b1)
or preferably with at least one polyisocyanate (b2).

Polyamines (b1) can be aliphatic, cycloaliphatic or preferably aromatic. In polyamine (b1) only primary amino groups (NH₂-groups) will be taken into account. Tertiary and secondary amino groups—if present—will not be taken into consideration when determining the number of amino groups in polyamine (b1).

Polyamine (b1) has on average more than two amino groups per molecule, preferably on average at least 2.5, more preferably on average at least 3.0.

In one embodiment, polyamines (b1) are selected from mixtures from diamines and triamines.

In one embodiment of the present invention, polyamine (b1) bears on average a maximum of 8, preferably on average a maximum of 6 amine groups per molecule.

Aromatic triamines and mixtures of aromatic or aliphatic diamines and aromatic triamines are particularly preferred examples for polyamines (b1).

Examples for aliphatic diamines to be present in said mixtures of mixtures of aromatic or aliphatic diamines and aromatic triamines as polyamines (b1) are ethylene diamine, 1,3-propylene diamine, diethylenetriamine, tetraethylenepentamine, and triethylenetetramine.

Suitable aromatic triamines that can be selected as polyamines (b1)—alone or as a mixture with at least one aromatic diamine—are chosen from triamines in which the NH₂ groups are attached to one or preferable to at least two aromatic rings, said different aromatic rings being so-called isolated aromatic rings, conjugated aromatic rings, or fused aromatic rings.

Preferably, triamines with NH₂-groups attached to different conjugated or isolated aromatic rings are selected.

Examples are 1,3,5-tri(4-aminophenoxy)benzene, 1,3,5-tri(3-methy 1,4-aminophenoxy)benzene, 1,3,5-tri(3-methoxy,4-aminophenoxy)benzene, 1,3,5-tri(2-methyl,4-aminophenoxy)benzene, 1,3,5-tri(2-methoxy,4-aminophenoxy)benzene, and 1,3,5-tri(3-ethyl,4-aminophenoxy)benzene.

Further examples for triamines are 1,3,5-tri(4-aminophenylamino)benzene, 1,3,5-tri(3-methyl,4-aminophenylamino)benzene, 1,3,5-tri(3-methoxy,4-aminophenylamino)benzene, 1,3,5-tri(2-methyl,4-aminophenylamino)benzene, 1,3,5-tri(2-methoxy,4-aminophenylamino)benzene, and 1,3,5-tri(3-ethyl,4-aminophenylamino)benzene.

Examples are triamines according to formula (VII)

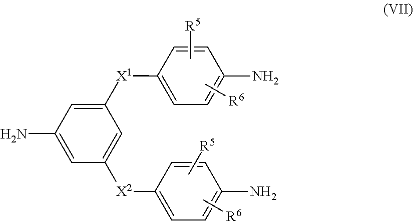

the integers being defined as follows:

R⁵, R⁶— being different or preferably identical and selected from hydrogen, C₁-C₄-alkyl, COOCH₃, COOC₂H₅, CN, CF₃, or O—CH₃;

X¹, X²—being different or preferably identical and selected from single bonds, C₁-C₄-alkylene groups, N—H, and oxygen, preferable —CH₂— or oxygen.

In one embodiment, polyamine (b1) is selected from 3,5-di(4-aminophenoxy)aniline, 3,5-di(3-methyl-1,4-aminophenoxy)aniline, 3,5-di(3-methoxy-4-aminophenoxy)aniline, 3,5-di(2-methyl-4-aminophenoxy)aniline, 3,5-di(2-methoxy-4-aminophenoxy)aniline, and 3,5-di(3-ethyl-4-aminophenoxy)aniline.

In one embodiment, examples are triamines according to formula (VIII)

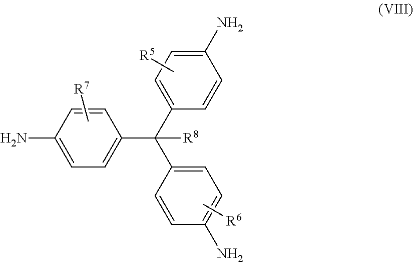

R⁷ selected from hydrogen, C₁-C₄-alkyl, COOCH₃, COOC₂H₅, CN, CF₃, or O—CH₃;

R⁸ selected from hydrogen or methyl

and the other integers being defined as above.

Polyisocyanate (b2) can be selected from any polyisocyanates that on average have more than two isocyanate groups per molecule, which can be capped or preferably free. Preference is given to trimeric or oligomeric diisocyanates, for example oligomeric hexamethylene diisocyanate, oligomeric isophorone diisocyanate, oligomeric tolylene diisocyanate, preferably trimeric tolylene diisocyanate, oligomeric diphenylmethane diisocyanate—hereinafter also termed polymer-MDI—and mixtures of the abovementioned polyisocyanates. For example, what is termed trimeric hexamethylene diisocyanate, in many cases, is not present as pure trimeric diisocyanate, but as polyisocyanate having a medium functionality of 3.6 to 4 NCO groups per molecule. The same applies to oligomeric tetramethylene diisocyanate and oligomeric isophorone diisocyanate.

In one embodiment of the present invention, polyisocyanate (b2) having more than two isocyanate groups per molecule is a mixture of at least one diisocyanate and at least one triisocyanate, or a polyisocyanate having at least 4 isocyanate groups per molecule.

In one embodiment of the present invention, polyisocyanate (b2) has on average at least 2.2, preferably at least on average 2.5, particularly preferably at least on average 3.0, isocyanate groups per molecule.

In one embodiment of the present invention, polyisocyanate (b2) bears on average a maximum of 8, preferably on average a maximum of 6 isocyanate groups per molecule.

In one embodiment of the present invention, polyisocyanate (b2) is selected from oligomeric hexamethylene diisocyanate, oligomeric isophorone diisocyanate, oligomeric diphenylmethane diisocyanate, and mixtures of the abovementioned polyisocyanates.

Polyisocyanate (b2) can, in addition to urethane groups, also have one or more other functional groups, for example urea, allophanate, biuret, carbodiimide, amide, ester, ether, uretonimine, uretdione, isocyanurate or oxazolidine groups.

When polyamine (b1) and polycarboxylic acid (a) are condensed with one another—preferably in the presence of a catalyst—an imide group is formed under elimination of H₂O.

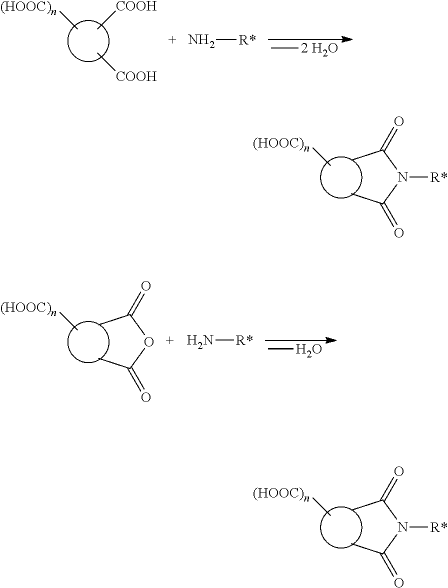

In the above formulae, R* is the polyamine (b1) radical that is not specified further in the above reaction equation, and n is a number greater than or equal to 1, for example 1 in the case of a tricarboxylic acid or 2 in the case of a tetracarboxylic acid. Optionally, (HOOC)ₙ can be replaced with a C(═O)—O—C(═O) moiety.

When polyisocyanate (b2) and polycarboxylic acid (a) are condensed with one another—preferably in the presence of a catalyst—an imide group is formed with the elimination of CO₂ and H₂O. If, instead of polycarboxylic acid (a), the corresponding anhydride is used, an imide group is formed with elimination of CO₂.

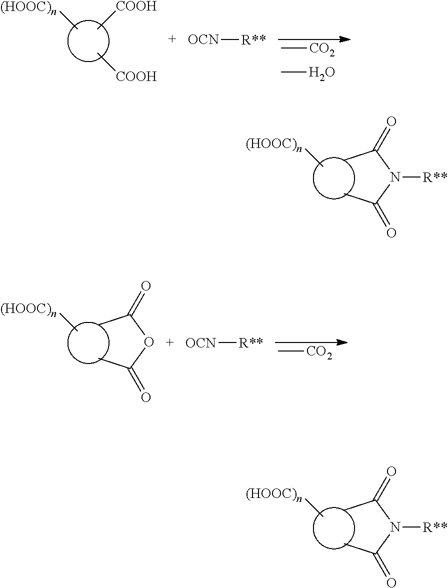

In the above formulae, R** is the polyisocyanate (b2) radical that is not specified further in the above reaction equation, and n is a number greater than or equal to 1, for example 1 in the case of a tricarboxylic acid or 2 in the case of a tetracarboxylic acid, and optionally, (HOOC)ₙ can be replaced with a C(═O)—O—C(═O) moiety.

In an embodiment of the present invention, polyisocyanate (b2) is used in a mixture with at least one diisocyanate, for example with tolylene diisocyanate, hexamethylene diisocyanate or with isophorone diisocyanate. In a particular variant, polyisocyanate (b2) is used in a mixture with the corresponding diisocyanate, for example trimeric HDI with hexamethylene diisocyanate or trimeric isophorone diisocyanate with isophorone diisocyanate or polymeric diphenylmethane diisocyanate (polymer MDI) with diphenylmethane diisocyanate.

In one embodiment of the present invention, polycarboxylic acid (a) is used in a mixture with at least one dicarboxylic acid or with at least one dicarboxylic anhydride, for example with phthalic acid or phthalic anhydride.

Some synthesis methods for making branched polyimides are described below.

Preferred synthesis methods for making branched polyimides comprise reacting with one another
(a) at least one polycarboxylic acid having at least 3 COOH groups per molecule or anhydride or ester thereof,
(b) at least one compound, selected from
   (b1) at least one polyamine having on average more than two amino groups per molecule and
   (b2) at least one polyisocyanate having on average more than two isocyanate groups per molecule.
      in the presence of a catalyst.

As catalysts, in particular water and BrØnsted bases are suitable, for example alkalimetal alcoholates, in particular alkanolates of sodium or potassium, for example sodium methanolate, sodium ethanolate, sodium phenolate, potassium methanolate, potassium ethanolate, potassium phenolate, lithium methanolate, lithium ethanolate and lithium phenolate.

For carrying out the synthesis method for making branched polyimides, polyisocyanate (b2) and polycarboxylic acid (a) or anhydride (a) can be used in a quantitative ratio such that the molar fraction of NCO groups to COOH groups is in the range from 1:3 to 3:1, preferably 1:2 to 2:1. In this case, one anhydride group of the formula CO—O—CO counts as two COOH groups.

In an embodiment of the present invention, catalyst can be used in the range from 0.005 to 0.1% by weight, based on the sum of polyisocyanate (b2) and polycarboxylic acid (a) or polyisocyanate (b2) and anhydride (a). Preference is given to 0.01 to 0.05% by weight of catalyst.

In an embodiment of the present invention, a synthesis method for making branched polyimides can be carried out at temperatures in the range from 50 to 200° C., preferably 50 to 140° C., particularly preferably 50 to 100° C.

In an embodiment of the present invention, a synthesis method for making branched polyimides can be carried out at atmospheric pressure. However, the synthesis is also possible under pressure, for example at pressures in the range from 1.1 to 10 bar.

In an embodiment of the present invention, a synthesis method for making branched polyimides can be carried out in the presence of a solvent or solvent mixture. Examples of suitable solvents are N-methylpyrrolidone, N-ethylpyrrolidone, dimethylformamide, dimethylacetamide, dimethyl sulfoxide, dimethyl sulphones, xylene, phenol, cresol, ketones such as, for example, acetone, methyl ethyl ketone (MEK), methyl isobutyl ketone (MIBK), acetophenone, in addition mono- and dichlorobenzene, ethylene glycol monoethyl ether acetate and mixtures of two or more of the abovementioned mixtures. In this case, the solvent or solvents can be present during the entire synthesis time or only during part of the synthesis.

The reaction can be carried out, for example, for a time period of 10 minutes to 24 hours.

In a preferred embodiment of the present invention, the synthesis method for making branched polyimides is carried out under inert gas, for example under argon or under nitrogen.

If water-sensitive BrØnsted base is used as catalyst, it is preferred to dry inert gas and solvent. If water is used as catalyst, the drying of solvent and inert gas can be dispensed with.

In a variant of the synthesis method for making branched polyimides, NCO end groups of branched polyimide can be blocked with a blocking agent (c), for example with secondary amine, for example with dimethylamine, di-n-butylamine or with diethylamine.

In one embodiment of the present invention, inventive electrochemical cells can contain additives such as wetting agents, corrosion inhibitors, or protective agents such as agents to protect any of the electrodes or agents to protect the salt(s).

In one embodiment of the present invention, inventive electrochemical cells can have a disc-like shape. In another embodiment, inventive electrochemical cells can have a prismatic shape.

In one embodiment of the present invention, inventive electrochemical cells can include a housing that can be from steel or aluminium.

In one embodiment of the present invention, inventive electrochemical cells are combined to stacks including electrodes that are laminated.

In one embodiment of the present invention, inventive electrochemical cells are selected from pouch cells.

Inventive electrochemical cells have overall advantageous properties. They have a long duration with very low loss of capacity, good cycling stability, and a reduced tendency towards short circuits after longer operation and/or repeated cycling.

A further aspect of the present invention refers to batteries containing at least one inventive electrochemical cell, for example two or more. Inventive batteries have advantageous properties. They have a long duration with very low loss of capacity, good cycling stability, and high temperature stability.

A further aspect of the present invention is the use of inventive electrochemical cells or inventive batteries according for making or operating cars, computers, personal digital assistants, mobile telephones, watches, camcorders, digital cameras, thermometers, calculators, laptop BIOS, communication equipment or remote car locks, and stationary applications such as energy storage devices for power plants. A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one inventive battery or at least one inventive electrochemical cell.

A further aspect of the present invention is the use of polyimides selected from branched condensation products of
(a) at least one polycarboxylic acid having at least 3 COOH groups per molecule or an anhydride or ester thereof,
(b) at least one compound, selected from
   (b1) at least one polyamine having on average more than two amino groups per molecule and
   (b2) at least one polyisocyanate having on average more than two isocyanate groups per molecule
   as or for manufacturing of separators in electrochemical cells.

A further aspect of the present invention is a separator, comprising at least one polyimide, selected from branched condensation products of
(a) at least one polycarboxylic acid having at least 3 COOH groups per molecule or an anhydride or ester thereof,
(b) and at least one compound, selected from
   (b1) at least one polyamine having on average more than two amino groups per molecule and
   (b2) at least one polyisocyanate having on average more than two isocyanate groups per molecule.

Polyisocyanate (b2) and polycarboxylic acids (a) have been defined above.

In one embodiment of the present invention, inventive separator (D) has a thickness in the range of from 10 μm to 100 μm, preferably 15 μm to 35 μm.

In one embodiment of the present invention, the specific ionic conductivity at room temperature of inventive separator (D) in liquid electrolyte is in the range of from 10⁻⁶ S/cm to 10⁻³ S/cm, determined by impedance measurements of sandwich cells with separator/electrolyte combinations.

A further aspect of the present invention is a method for manufacturing inventive separators. Said inventive method comprises making a film of branched polyimide.

In one embodiment of the inventive method, one dissolves at least one branched polyimide in a suitable solvent or mixture of solvents and then applies said solution to a flat surface, for example to a glass surface or to a metal foil, e.g., an aluminum foil, or to a plastics foil such as a polyethylene terephthalate film (PET foil). Then one removes the solvent or solvents, respectively. Afterwards, the inventive separator can be removed from the flat surface, for example mechanically.

Examples for suitable solvents are, e.g., cyclic or non-cyclic amides, ketones, and cyclic and non-cyclic ethers.

Examples for cyclic amides are N-methylpyrrolidone (NMP) and N-ethylpyrrolidone (NEP). Examples for non-cyclic amides are N,N-dimethylformamide and N,N-dimethylacetamide. Examples for ketones are acetone, methylethylketone, methyl isobutyl ketone (MIBK), and cyclohexanone. Examples for ethers are 1,2-dimethoxyethane, di-n-butyl ether, tetrahydrofurane and preferably anisole.

Solutions of at least one branched polyimide can have a solids content in the range of from 5 to 50% by weight, preferably 15 to 30% by weight.

Application of the solution to a flat surface can be performed by spraying, blade coating, spin coating, drop casting, or dip coating.

Removal of the solvent(s) can be achieved by evaporating the solvent(s) or allowing to evaporate, for example by heating, or via reduction of pressure, or via using a gas stream.

Removal of the separator from the flat surface can be achieved by mere mechanical means, or it can be supported by softening, e.g., by allowing to rest in a solvent with poor solution ability, such as water.

In another embodiment, inventive separators can be made by applying a solution of
(a) at least one polycarboxylic acid having at least 3 COOH groups per molecule or an anhydride or ester thereof,
(b) and at least one compound, selected from
   (b1) at least one polyamine having on average more than two amino groups per molecule and
   (b2) at least one polyisocyanate having on average more than two isocyanate groups per molecule.
      to a flat surface, and allow to in situ form at least one branched polyimide. Then the solvent(s) is/are removed.

Inventive separators (D) have overall advantageous properties. They help to secure a long duration of electrochemical cells with very low loss of capacity, good cycling stability, and a reduced tendency towards short circuits after longer operation and/or repeated cycling. They can help batteries to have a long duration with very low loss of capacity, good cycling stability, and high temperature stability.

The present invention will be illustrated by non-limiting working examples.

### Working Examples

### General Remarks

Polycarboxylic acid (a.1): dianhydride of 1,2,4,5-benzene tricarboxylic acid

Polyisocyanate (b2.1): polymeric 4,4′-diphenylmethane diisocyanate (“Polymer-MDI”), average of 2.7 isocyanate groups per molecule, dynamic viscosity: 195 mPa·s at 25° C., commercially available as Lupranat® M20W.

Polyisocyanate (b2.2): Isocyanurate from hexamethylendiisocyanate, average of 3,6 isocyanate groups per molecule.

“NCO”: NCO content, determined by IR spectroscopy unless expressly mentioned otherwise, it is indicated in % by weight.

The molecular weights were determined by gel permeation chromatography (GPC using a refractometer as detector). The standard used was polymethyl methacrylate (PMMA). The solvents used were N,N-dimethylacetamide (DMAc) or tetrahydrofurane (THF), if not stated otherwise.

Percentages are % by weight unless expressly mentioned otherwise.

### I.1 Synthesis of Branched Polyimide BP.1

An amount of 100 g of (a.1) (0.46 mole), dissolved in 1400 ml of acetone, were placed in a 4 liter four-neck flask having a dropping funnel, reflux condenser, internal thermometer and Teflon stirrer, and 0.1 g of water was added. Then, 465 g (1.38 mole) of polyisocyanate (b2.1) were added dropwise at 20° C. The mixture was heated with stirring to 55° C. The mixture was stirred for a further seven hours under reflux at 55° C. Then, the temperature was slowly raised to 135° C. and the acetone was distilled off. The molecular weight and the NCO content were determined from an aliquot. Branched polyimide BP.1 was obtained.

Mₙ: 3,050 g/mol, M_{w}: 8,800 g/mol (in DMAc)

NCO: 20%

### I.2 Synthesis of Branched Polyimide BP.2

An amount of 100 g of (a.1) (0.46 mole), dissolved in 1400 ml of acetone, were placed in a 4 liter four-neck flask having a dropping funnel, reflux condenser, internal thermometer and Teflon stirrer, and 0.1 g of water was added. Then, 400 g (1.19 mole) of polyisocyanate (b2.1) were added dropwise at 20° C. The mixture was heated with stirring to 55° C. The mixture was stirred for a further six hours under reflux at 55° C. The molecular weight and the NCO content were determined from an aliquot.

Mₙ=3,300 g/mol, M_{w}=4,820 g/mol (in DMAc)

M_{w}/Mₙ=1.5

NCO: 27.8% (measured according to DIN EN ISO 11909)

Then the sample was diluted by addition of 350 g from a 1:1 mixture of 2,4′-diphenylmethandiisocyanate and 4,4′-diphenylmethandiisocyanate. The acetone was then distilled off over a time of one hour at normal pressure. At the end of the distillation the temperature was raised to 70° C., the pressure was reduced to 200 mbar and the residue was stripped by using a nitrogen stream. Branched polyimide BP.2 was obtained.

Mₙ=2,380 g/mol, M_{w}=3,000 g/mol, M_{w}/Mₙ=1.3 (in DMAc)

NCO: 29.4% (measured according to DIN EN ISO 11909)

### I.3 Synthesis of Branched Polyimide BP.3

An amount of 33 g of (a.1) (0.15 mole), dissolved in 467 ml of acetone, were placed in a 4 liter four-neck flask having a dropping funnel, reflux condenser, internal thermometer and Teflon stirrer, and 0.05 g of water was added. Then, 50 g (0.075 mole) of polyisocyanate (b2.2) were added dropwise at 20° C. The mixture was heated with stirring to 55° C. The mixture was stirred for a further six hours under reflux at 55° C. Branched polyimide BP.3 was obtained. The molecular weight and the NCO content were determined from an aliquot. The acetone was then distilled off over a time of one hour at normal pressure. At the end of the distillation the temperature was raised to 70° C., the pressure was reduced to 200 mbar and the residue was stripped by using a nitrogen stream. Branched polyimide BP.3 was obtained.

M_{w}: 2,166 g/mol (in THF)

### I.4 Synthesis of Branched Polyimide BP.4

An amount of 100 g of (a.1) (0.46 mole), dissolved in 300 g N-methylpyrrolidone (NMP), were placed in a 2 liter four-neck flask having a dropping funnel, reflux condenser, internal thermometer and Teflon stirrer, and 0.1 g of water was added. The mixture was heated with stirring to 80° C. Then, 142 g (0.22 mole) of polyisocyanate (b2.2) were added dropwise at 80° C. within a time range of six hours. The mixture was heated with stirring for further ten hours at 80° C. The mixture was cooled down to room temperature and an aliquot of the branched polyimide BP.4 so obtained was analyzed.

Mₙ: 1,013 g/mol, M_{w}: 3,877 g/mol, M_{w}/Mₙ: 3.8 (in THF)

### I.5 Synthesis of Branched Polyimide BP.5

An amount of 100 g of (a.1) (0.46 mole), dissolved in 300 g NMP, were placed in a 2 liter four-neck flask having a dropping funnel, reflux condenser, internal thermometer and Teflon stirrer, and 0.05 g of water was added. The mixture was heated with stirring to 80° C. Then, 142 g (0.22 mole) of polyisocyanate (b2.2) were added dropwise at 80° C. within a time range of one hour. The mixture was heated with stirring for further four hours at 80° C. Then, 38 g of polyisocyanate (b2.1) were added to the reaction mixture within a time range of 1 hour at 80° C. The mixture was cooled down to room temperature and an aliquot of the branched polyimide BP.5 so obtained was analyzed.

Mₙ: 591 g/mol, M_{w}: 2,549 g/mol, M_{w}/Mₙ: 4.3 (in THF)

NCO: 7.92% (measured according to DIN EN ISO 11909)

### I.6 Synthesis of Branched Polyimide BP.6

An amount of 100 g of (b.1) (0.46 mole), dissolved in 300 g NMP, were placed in a 2 liter four-neck flask having a dropping funnel, reflux condenser, internal thermometer and Teflon stirrer, and 0.1 g of NaOCH₃ was added. The mixture was heated with stirring to 80° C. Then, 142 g (0.22 mole) of polyisocyanate (b2.2) were added dropwise at 80° C. within a time range of one hour. The mixture was heated with stirring for further ten hours at 80° C. The mixture was cooled down to room temperature and an aliquot of the residue so obtained was analyzed.

NCO 6.8% (measured according to DIN EN ISO 11909)

Then, 117 g of di-n-butylamine (c.1) were added at room temperature over a time range of 117 g and the reaction mixture was further heated for two hours. Then the branched polyimide BP.6 was isolated via precipitation in water followed by drying at 80° C. under reduced pressure. The branched polyimide BP.6 so obtained was analyzed via GPC

Mₙ: 5,820 g/mol, M_{w}: 57,900 g/mol, M_{w}/Mₙ: 10 (in DMAc)

### II. Manufacture of Inventive Separator (D.1)

Branched polyimide (BP.1) (3 g) was dissolved in 10 g NMP as solvent and warmed to 80° C. The 30% solution so obtained was applied at 80° C. with a doctor blade method to a glass plate. The solvent-containing film had a thickness of 50 μm. The NMP was allowed to evaporate for 10 minutes at 80° C. The film was then—together with the glass plate—placed into a water bath having room temperature for 1 hour. Then, a film was be removed manually which was dried over a period of 24 hours under vacuum at 80° C. Inventive separator (D.1) was so obtained.

The specific electric conductivity of inventive separator (D.1) was 10⁻⁵ S/cm, determined in a 1 M solution of LiPF₃(CF₂CF₃)₃ in a 1:1 (by weight) mixture of ethylene carbonate/dimethyl carbonate.

### III. Test of Inventive Separator (D.1) in a Lithium Ion Battery

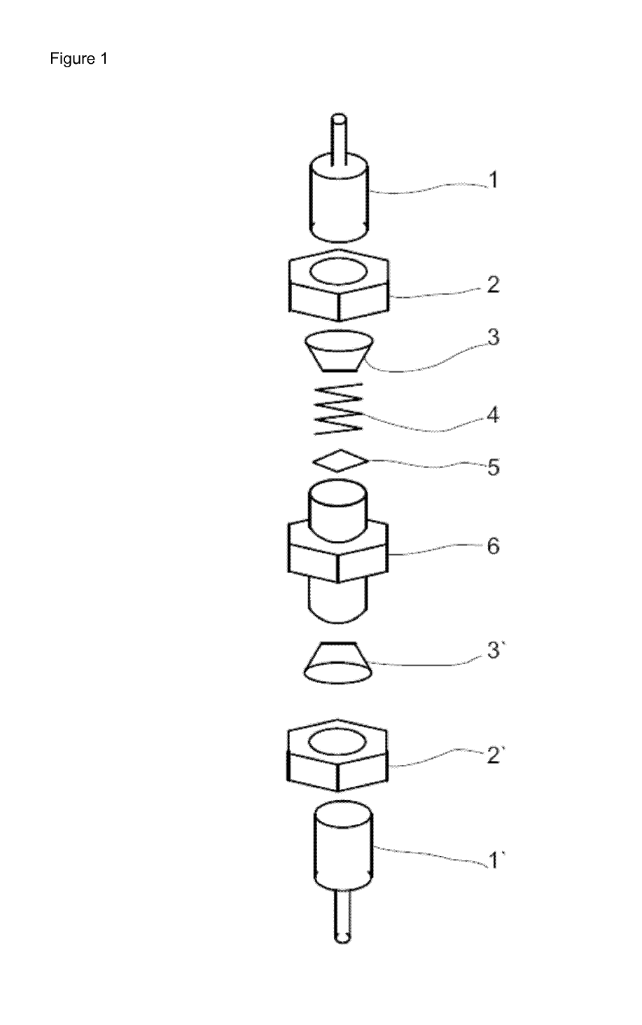

An inventive electrochemical cell (EC.1) according to FIG. 1 was assembled.

FIG. 1 shows an exploded view of inventive electrochemical cell (EC. 1).

The labels in FIG. 1 mean:
1, 1′ Dies
2, 2′ Nuts
3, 3′ Sealing ring—two in each case, the second sealing ring in each case, which is somewhat smaller, not being shown here
4 Coil spring
5 Nickel output conductor
6 Housing

Anode: graphite on copper foil as current collector with a thickness of 36 to 38 μm.

Cathode: LiNi_{0.8}Co_{0.15}Al_{0.05}O₂, on aluminium foil as current collector.

1M solution of LiPF₃(CF₂CF₃)₃ in a 1:1 (by weight) mixture of ethylene carbonate/dimethyl carbonate

As cathode (B.1), a nickel manganese spinel electrode was used which had been manufactured as follows.

85% LiMn_{1.5}Ni_{0.5}O₄

6% PVdF, commercially available as Kynar Flex® 2801 of Arkema Group,

6% carbon black, BET surface 62 m²/g, commercially available as “Super P Li” by Timcal,

3% graphite, commercially available as KS6 by Timcal,

were mixed in a container with a lid. Under stirring, an amount of NMP was added until a viscous lump-free paste was obtained. Stirring was performed over a time of 16 hours.

The paste so obtained was applied to an aluminium foil (thickness of the aluminium foil: 20 μm) with a knife blade. Then, the aluminium foil so coated was dried in a drying cabinet at 120° C. under vacuum. The thickness of the dried coating was 30 μm. Then round segments were punched out, diameter: 12 mm.

Inventive electrochemical cell (EC.1) was charged with a constant current to a voltage of 4.2 V followed by a final charging with constant voltage at 4.2 V. Then, inventive electrochemical cell (EC.1) was discharged at constant current to a voltage of 3 V. Three such cycles with 0.1 C and, thereafter, 20 cycles with 0.5 C were determined. The capacity was determined to be 90 to 100 mA·h.

1. An electrochemical cell comprising
an anode,
a cathode,
a non-aqueous electrolyte,
a separator positioned between the anode and the cathode, wherein the separator comprises a polyimide selected from branched condensation products of
a polycarboxylic acid having at least 3 COOH groups per molecule or an anhydride or ester thereof, and
at least one compound selected from the group consisting of
a polyamine having on average more than two amino groups per molecule and
a polyisocyanate having on average more than two isocyanate groups per molecule.

2. The electrochemical cell according to claim 1, wherein the polycarboxylic acid is a polycarboxylic acid having at least 4 COOH groups per molecule, or an anhydride or ester thereof.

3. The electrochemical cell according to claim 1, wherein the polyisocyanate is at least one selected from the group consisting of oligomeric hexamethylene diisocyanate, oligomeric tetramethylene diisocyanate, oligomeric isophorone diisocyanate, oligomeric diphenylmethane diisocyanate, and oligomeric tolylene diisocyanate.

4. The electrochemical cell according to claim 1, wherein the separator has a thickness of from 1 to 100 μm.

5. The electrochemical cell according to claim 1, wherein the cell is a lithium-ion comprising cell.

6. The electrochemical cell according to claim 1, wherein the anode is selected from the group consisting of graphite anode and lithium titanate anode.

7. The electrochemical cell according to claim 1, wherein the cathode comprises at least one material selected from the group consisting of lithium comprising a transition metal spinel and lithium transition metal oxide with a layered crystal structure.

8. The electrochemical cell according to claim 1, wherein the polyimide has a polydispersity M_{w}/Mₙ of at least 1.4.

9. The electrochemical cell according to claim 7, wherein the lithium transition metal oxide with a layered crystal structure has formula Li₍₁₊ₓ₎[NiₑCo_{f}Mn_{g}M²ₕ]₍₁₋ₓ₎O₂,
wherein
x is a number of from zero to 0.2,
e is a number of from 0.2 to 0.6,
f is a number of from 0.1 to 0.5,
g is a number of from 0.2 to 0.6,
h is a number of from zero to 0.2,
e+f+g+h=1, and
M² is selected from the group consisting of Al, Mg, V, Fe, Cr, Zn, Cu, Ti and Mo.

10. The electrochemical cell according to claim 1, wherein the cathode comprises a material based on electrically conductive carbon.

11. A battery comprising the electrochemical cell according to claim 1.

12. The electrochemical cell according to claim 1, wherein the cell is suitable for making or operating cars, computers, personal digital assistants, mobile telephones, watches, camcorders, digital cameras, thermometers, calculators, laptop BIOS, communication equipment or remote car locks.

13. A method for manufacturing a separator, the method comprising:
dissolving a branched polyimide in a solvent to obtain a solution;
applying the solution to a flat surface;
removing the solvent; and
removing the separator from the flat surface,
wherein
the polyimide is selected from branched condensation products of
a polycarboxylic acid having at least 3 COOH groups per molecule or an anhydride or ester thereof, and
at least one compound selected from the group consisting of
a polyamine having on average more than two amino groups per molecule and
a polyisocyanate having on average more than two isocyanate groups per molecule.

14. A separator, comprising a polyimide selected from branched condensation products of
a polycarboxylic acid having at least 3 COOH groups per molecule or an anhydride or ester thereof, and
at least one compound selected from the group consisting of
a polyamine having on average more than two amino groups per molecule and
a polyisocyanate having on average more than two isocyanate groups per molecule.

15. The separator according to claim 14, further comprising inorganic particles.
